(19) United States
(12) Patent Application Publication
(10) Pub. No.: US 2018/0105211 A1
(43) Pub. Date: Apr. 19, 2018

(54) HINGE COVER FOR A DITCH MOUNTED LIFTGATE ASSEMBLY

(71) Applicant: FORD GLOBAL TECHNOLOGIES, LLC, Dearborn, MI (US)

(72) Inventors: David Lee Jarvis, Madison Heights, MI (US); Bradley Mark Prochazka, Livonia, MI (US)

(21) Appl. No.: 15/292,190

(22) Filed: Oct. 13, 2016

(51) Int. Cl. B62D 25/07; B60R 13/04

(52) U.S. Cl. CPC B62D 25/07; B60R 13/04

(57) ABSTRACT

A vehicle includes a roof ditch extending longitudinally, a first trim component covering a first portion of the roof ditch, a hinge mounted to a second portion of the roof ditch and connected to a liftgate, and a second trim component supported for pivotal movement. The second trim component covers the second portion of the roof ditch and at least a portion of the hinge. The roof ditch is formed by layers including at least one of a roof, a body side, and a reinforcement. The first trim component may be a molding and/or a roof rail covering the first portion of the roof ditch. A related method of adjusting a liftgate includes the steps of applying a force to a first end of a trim component in a closed position sufficient to overcome a holding force of a fastener, pivoting the first end of the trim component to an open position to reveal a hinge fastened to a roof ditch and the liftgate, loosening at least one fastener, adjusting the liftgate, tightening the at least one fastener, and returning the trim component to the closed position.

### TECHNICAL FIELD

This document relates generally to vehicle covers, and more specifically to a hinge cover for a liftgate assembly.

### BACKGROUND

Vehicles typically include drain ditches extending in a generally longitudinal direction of the vehicle and forming a water management channel along both the driver and passenger sides. The drain ditches are typically covered with trim as are liftgate hinges which form a part of the liftgate assembly and connect the liftgate to the body of the vehicle. When liftgate hinge adjustment, including replacement, is required, the cover or trim is required to be removed. This task is time consuming and increases the potential for damage to the trim components. In certain situations, for example when roof rails are mounted to the vehicle, the trim removal can further require removal of interior trim components in addition to the noted exterior trim components. This further complicates the procedure and increases the potential for damage to trim components and elevated costs.

Accordingly, a need exists for a hinge cover or trim component that provides access to the underlying liftgate hinge without requiring removal of the cover/trim component or other trim components. Such a hinge cover may itself be hinged, whether a living hinge or otherwise, allowing for adjustment, including replacement, of liftgate hinges without the need to remove additional trim covers from the roof. Advantageously, this minimizes the time required for adjustment and lowers the potential for damage to trim covers when being removed and replaced. Even more, the need to remove interior and exterior trim covers is eliminated.

### SUMMARY OF THE INVENTION

In accordance with the purposes and benefits described herein, a vehicle is provided. The vehicle may be broadly described as including a roof ditch extending longitudinally, a first trim component covering a first portion of the roof ditch, a hinge mounted to a second portion of the roof ditch and connected to a liftgate, and a second trim component supported for pivotal movement. The second trim component covers a second portion of the roof ditch and at least a portion of the hinge.

In another possible embodiment, the roof ditch is formed by at least one of a roof and a body side. In another, the roof ditch is further formed by a reinforcement.

In yet another possible embodiment, the first trim component is a molding covering the first portion of the roof ditch.

In still another possible embodiment, a roof rail extends along at least a portion of the roof ditch. In another, the roof rail extends from a first end to a second end of the first portion of the roof ditch.

In one additional possible embodiment, the first trim component is a roof rail covering the first portion of the roof ditch.

In yet still another possible embodiment, at least a portion of the second portion of the roof ditch is flared.

In one additional possible embodiment, a vehicle includes a roof ditch formed by at least one of a roof, a side body, and a reinforcement, a first trim component covering a first portion of the roof ditch, a hinge mounted within a second portion of the roof ditch and connected to a liftgate, and a second trim component abutting the first trim component and covering the second portion of the roof ditch and at least a portion of the hinge, the second trim component pivotally connected to the first trim component.

In another possible embodiment, the first trim component is a molding covering at least a portion of the first portion of the roof ditch.

In still another possible embodiment, the vehicle further includes a roof rail extending along the at least a portion of the first portion of the roof ditch and attached at a first end of the first portion of the roof ditch to accommodate the pivotal movement of the second trim component.

In yet another possible embodiment, the first trim component is a roof rail covering at least a portion of the first portion of the roof ditch.

In one other possible embodiment, the at least a portion of the second portion of the roof ditch is flared. In still another, the first trim component and the second trim component are pivotally connected by a living hinge.

In another possible embodiment, a method is provided adjusting a liftgate of a vehicle. The method may be broadly described as comprising the steps of: (a) applying a force to a trim component in a closed position sufficient to overcome a holding force of a fastener; (b) pivoting the first end of the trim component to an open position to reveal a hinge fastened to a roof ditch and the liftgate; (c) loosening at least one fastener; (d) adjusting the liftgate; (e) tightening the at least one fastener; and (f) returning the trim component to the closed position.

In one possible embodiment, the roof ditch is formed by at least one of a roof, a body side, and a reinforcement. In another, the roof ditch is further formed by a reinforcement.

In another possible embodiment, the adjusting step includes replacing the liftgate with a replacement liftgate.

In the following description, there are shown and described several embodiments of a vehicle having a trim component supported for pivotal movement and covering a portion of a roof ditch and a liftgate hinge. As it should be realized, the invention is capable of other, different embodiments and its several details are capable of modification in various, obvious aspects all without departing from the assemblies as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the vehicle having a trim component supported for pivotal movement and covering a portion of a roof ditch and a liftgate hinge and together with the description serve to explain certain principles thereof. In the drawing figures:

FIG. 1 is a top plan view of a vehicle having a liftgate;

FIG. 2 is a partial cross section plan view of a roof ditch formed by a roof, a side body and a reinforcement;

FIG. 3 is a partial top view of first and second trim components and a liftgate mounted to a roof ditch;

FIG. 4 is partial perspective view of a second trim component covering a portion of a roof ditch;

FIG. 5 is a partial perspective view of the second trim component pivoted to an open position revealing a portion of a hinge mounted to a roof ditch; and

FIG. 6 is a partial cross section plan view of pivotally connected first and second trim components.

Reference will now be made in detail to the present preferred embodiments of the vehicle having a trim component supported for pivotal movement and covering a portion of a roof ditch and a liftgate hinge, examples of which are illustrated in the accompanying drawing figures, wherein like numerals are used to represent like elements.

### DETAILED DESCRIPTION

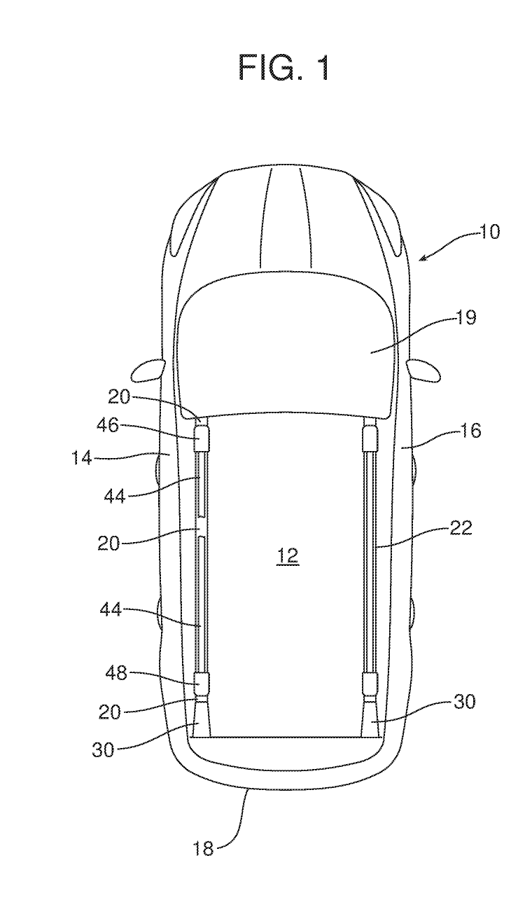

Reference is now made to FIG. 1 which illustrates a top view of a vehicle 10. The vehicle includes a roof 12, a driver side body 14, a passenger side body 16, a liftgate 18, and a windshield 19. A trim component 20 (positioned beneath a roof rail) covers a portion of a roof ditch 24 extending longitudinally along the driver side of the vehicle 10. A roof ditch 26 similarly extends longitudinally along the passenger side of the vehicle 10 and a portion of the passenger side roof ditch is also partially covered by a trim component 22.

In the described embodiment, the trim components 20 and 22 are moldings covering the first portions of roof ditches 24 and 26. Second trim components 28 and 30 cover second portions of the roof ditches 24 and 26 and at least portions of first and second liftgate hinges 32 and 34. It should be noted that the driver and passenger side roof ditches and trim components are essentially mirror images of one another, in the described embodiment, and only the driver side elements will be referred to or described hereinafter.

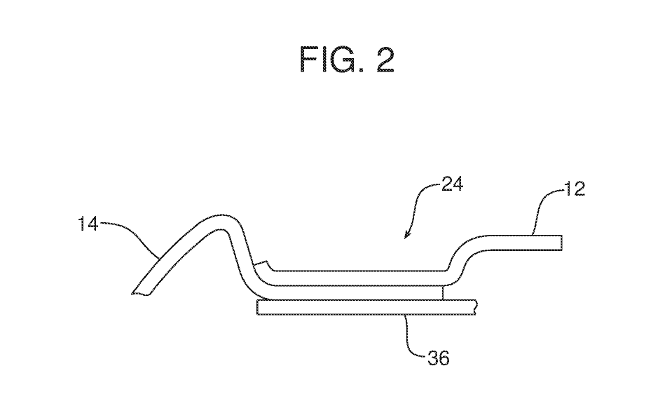

As shown in FIG. 2, the driver side roof ditch 24 in the described embodiment is formed by overlapping layers including the roof 12, the side body 14, and a reinforcement 36 to act as a water management system. The overlapping layers may be secured together by welding, riveting, or other methods known in the art. In alternate embodiments, the roof ditch 24 may be formed using any combination of layers of the roof 12, side body 14, and the reinforcement 36. For example, the roof ditch 24 may be formed without a reinforcement 36, with just the roof 12 and a reinforcement, or with just the side body 14 and the roof.

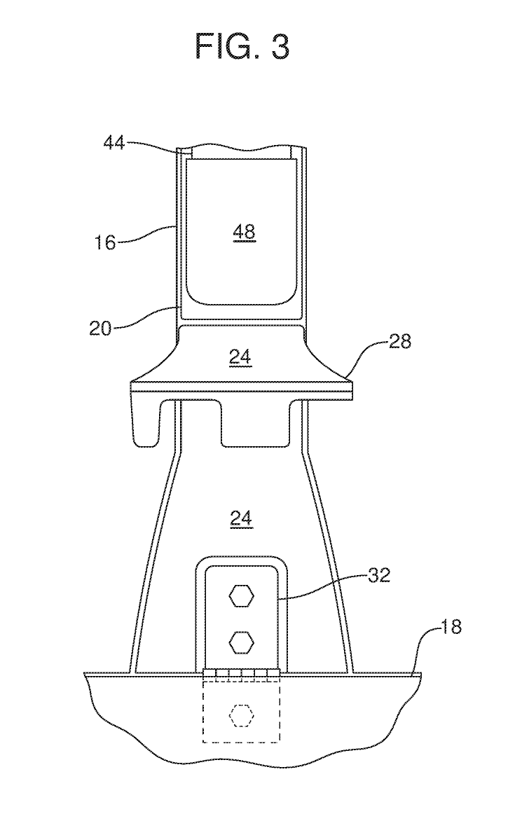

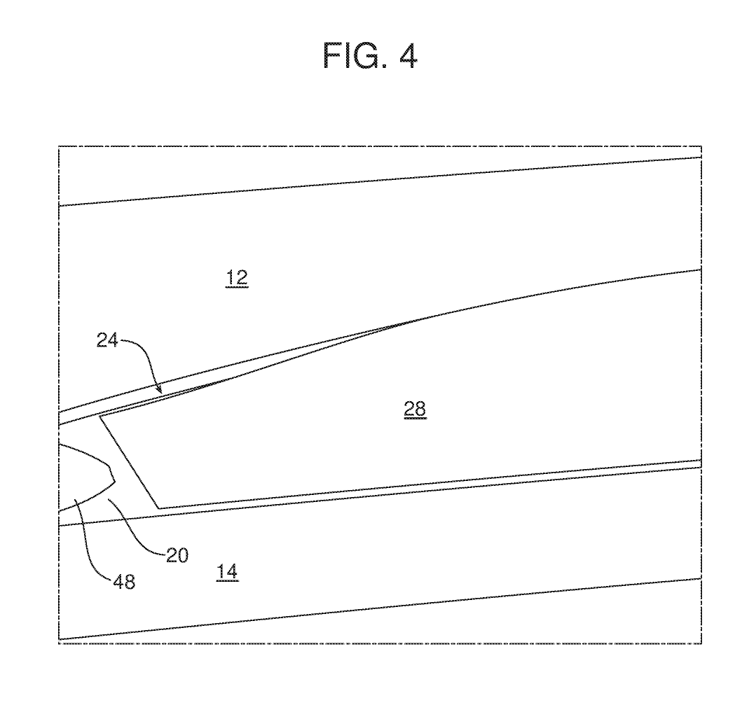

As suggested above and shown in FIG. 3, the first liftgate hinge 32 is mounted to the roof ditch 24 adjacent and connected to the liftgate 18 which is only partially shown. This arrangement, which is the same for the second liftgate hinge 34, allows the liftgate 18 to pivot about the hinges during movement between open and closed positions. Hydraulic liftgate arms (not shown) provide additional support for the liftgate 18 as is known in the art. The described liftgate hinge 32 is mounted within the roof ditch 24 and covered by the second trim component 28. The second trim component 28 is itself pivotally mounted for movement between an open position (shown in FIG. 3) and a closed position (shown in FIG. 4) to allow access to the liftgate hinge 32.

As further shown in FIG. 4, the first trim component 20 extends along the roof ditch 24 and abuts the second trim component 28. In the described embodiment, the first trim component 20 and the second trim component 28 are generally flush with the roof 12 and side body 14 to provide a desired aesthetic look and each component flares outwardly corresponding to a flare of the first and second portions of the roof ditch 24. In other embodiments, however, the roof ditch 24 may not include a flared portion at all or the flared portion may be limited to the second portion of the roof ditch 24 or even a portion thereof. In either instance, the first trim component 20 and the second trim component 28 are configured accordingly.

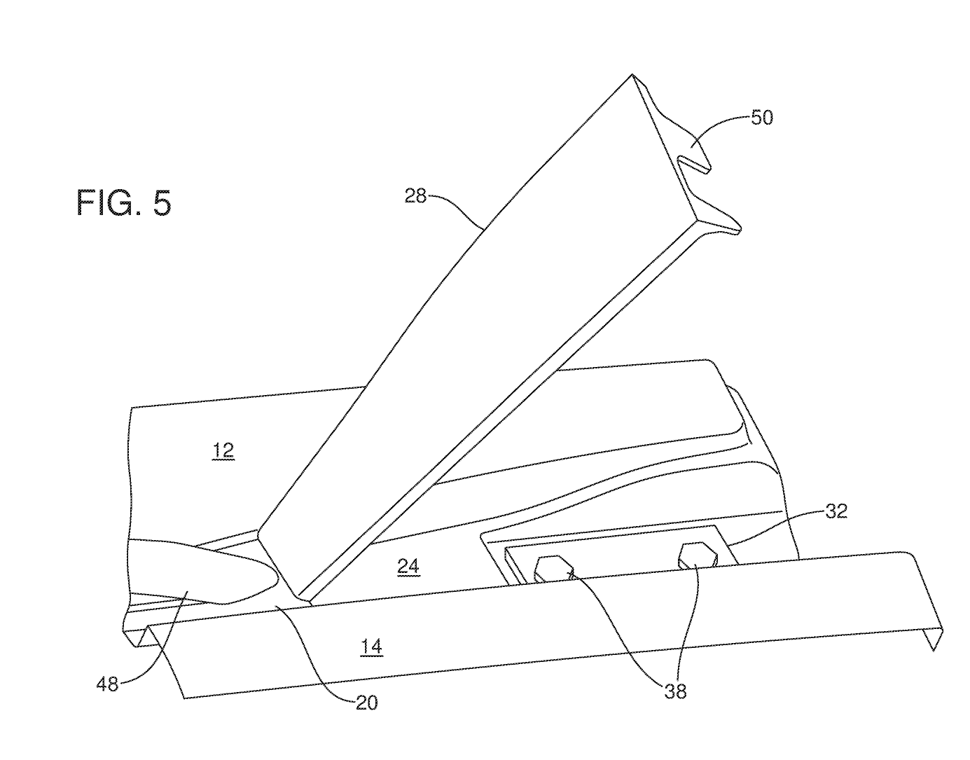

Turning to FIG. 5, the second trim component 28 is shown pivoted upward in an open position. In this position, the fasteners 38 used to mount the liftgate hinge 32 to the roof ditch 24 are exposed allowing a technician or car owner to access the fasteners without removing either the first or second trim components 20, 28, or other interior or exterior components.

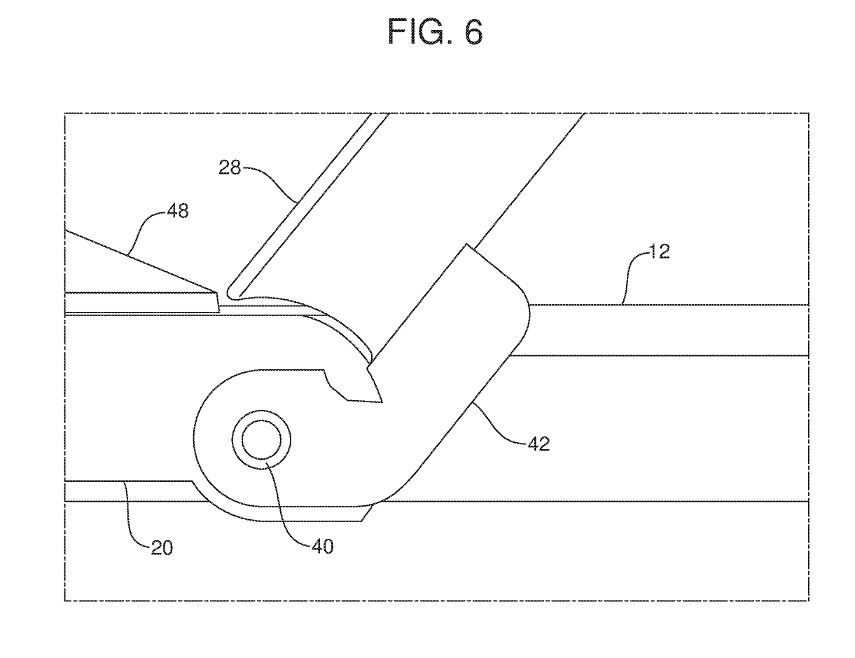

As shown in FIG. 6, the second trim component 28 is pivotally supported for movement between open and closed positions. In the described embodiment, the first trim component 20 covering the first portion of the roof ditch 24 includes an axis 40 about which an arm 42 extending from the second trim component 28 pivots or rotates. This allows the second trim component 28 to move between the closed position and the open position shown in this figure. In an alternate embodiment, the first trim component 20 and the second trim component 28 may be integrally formed such that a living hinge connects the components and supports the pivotal movement. In another alternate embodiment, the first trim component 20 and the second trim component 28 may be formed to include a ball and socket arrangement to provide the pivotal movement. In yet other embodiments, the first trim component 20 is secured within and covers a first portion of the roof ditch 24 and the second trim component 28 is attached for pivotal movement to the roof ditch 24 and covers the second portion of the roof ditch.

As best shown in FIG. 1, the vehicle 10 may further include a roof rail 44 extending longitudinally along at least a portion of the roof ditch 24. As shown, the roof rail 44 extends from a first end 46 to a second end 48 along the first portion of the roof ditch 24 in the described embodiment. The first end 46 and/or the second end 48, however, may be positioned anywhere along the first portion of the roof ditch 24. For example, the first end 46 may be positioned near the vehicle windshield 19 and the second end near a midpoint of the first portion of the roof ditch 24. In the embodiment shown in FIG. 6, the second end 48 of the roof rail 44 is positioned so as not to interfere with the pivotal movement of the second trim component 28.

In operation, the vehicle operator or a technician may adjust, (e.g., straighten or replace) the liftgate 18 of the vehicle 10 or its hinges. As a first step, a force is applied to the second trim component 28 sufficient to overcome a holding force of a fastener. In the described embodiment, the fastener (not shown) is a W-clip or a molded-in fastener positioned near an end 50 of the second trim component, but any type of fastener may be utilized in alternate embodiments. Once the holding force is overcome, the second trim component 28 is able to be pivoted between the closed position and an open position revealing the underlying liftgate hinge 32.

As described above, the liftgate hinge 32 is mounted to the roof ditch 24 which is formed by the roof 12, the body side 14, and a reinforcement 36. The liftgate hinge 32 is further attached or connected to the liftgate 18. Once exposed, the one or more fasteners 38 are loosened allowing for adjustment of the liftgate 18. In one embodiment, the fasteners 38 are loosened allowing for movement of the liftgate hinge 32 to orient the liftgate 18 in a desired manner. In another embodiment, the fasteners 38 may be loosened, including loosened until completely removed, to accommodate the adjustment of the liftgate 18. In other words, the fasteners 38 are removed to allow the liftgate 18 to be removed and subsequently replaced. The liftgate 18 may be removed for repair prior to replacement or may simply be replaced with a different liftgate. Once the liftgate 18 is adjusted, whether re-oriented or replaced, the loosened fasteners 38 are tightened in the desired position, and the second trim component 28 is returned to the closed position.

In summary, numerous benefits result from the utilization of a vehicle 10 having a trim component 28 supported for pivotal movement and covering a portion of a roof ditch 24 and a liftgate hinge 32 as illustrated in this document. The trim component 28 provides access to the underlying liftgate hinge 32 without requiring removal of the trim component or other trim components. Advantageously, this minimizes the time required for adjustment and/or replacement of the liftgate 18 and lowers the potential for damage to all trim covers when being removed and replaced. Even more, the need to remove interior and exterior trim covers is eliminated.

The foregoing has been presented for purposes of illustration and description. It is not intended to be exhaustive or to limit the embodiments to the precise form disclosed. Obvious modifications and variations are possible in light of the above teachings. All such modifications and variations are within the scope of the appended claims when interpreted in accordance with the breadth to which they are fairly, legally and equitably entitled.

1. A vehicle, comprising:
a roof ditch extending longitudinally;
a first trim component covering a first portion of said roof ditch;
a hinge mounted to a second portion of said roof ditch and connected to a liftgate; and
a second trim component attached to said first trim component for pivotal movement, said second trim component covering said second portion of said roof ditch and at least a portion of said hinge.

2. The vehicle of claim 1, wherein said roof ditch is formed by at least one of a roof and a body side.

3. The vehicle of claim 2, wherein said roof ditch is further formed by a reinforcement.

4. The vehicle of claim 1, wherein said first trim component is a molding covering said first portion of said roof ditch.

5. The vehicle of claim 4, wherein said roof ditch is formed by at least one of a roof, a body side, and a reinforcement.

6. The vehicle of claim 4, further comprising a roof rail extending along at least a portion of said roof ditch.

7. The vehicle of claim 6, wherein said roof rail extends from a first end to a second end of said first portion of said roof ditch.

8. The vehicle of claim 1, wherein said first trim component is a roof rail covering said first portion of said roof ditch.

9. The vehicle of claim 1, wherein at least a portion of said second portion of said roof ditch is flared.

10. A vehicle, comprising:
a roof ditch formed by at least one of a roof, a side body, and a reinforcement;
a first trim component covering a first portion of said roof ditch;
a hinge mounted within a second portion of said roof ditch and connected to a liftgate; and
a second trim component abutting said first trim component and covering said second portion of said roof ditch and at least a portion of said hinge, said second trim component pivotally connected to said first trim component.

11. The vehicle of claim 10, wherein said first trim component is a molding covering at least a portion of said first portion of said roof ditch.

12. The vehicle of claim 11, further comprising a roof rail extending along said at least a portion of said first portion of said roof ditch and attached at a first end of said first portion of said roof ditch to accommodate pivotal movement of said second trim component.

13. The vehicle of claim 10, wherein said first trim component is a roof rail covering at least a portion of said first portion of said roof ditch.

14. The vehicle of claim 10, wherein at least a portion of said second portion of said roof ditch is flared.

15. The vehicle of claim 10, wherein said first trim component and said second trim component are pivotally connected by a living hinge.

16-20. (canceled).

21. The vehicle of claim 1, wherein an arm extending from said second trim component receives a pivot.

22. The vehicle of claim 21, wherein said arm is attached to a lower edge of said second trim component.
